(19) United States
(12) Patent Application Publication
(10) Pub. No.: US 2008/0117865 A1
(43) Pub. Date: May 22, 2008

(54) COMMUNICATION IN A WIRELESS NETWORK USING MULTIPLE ANTENNAE

(76) Inventors: Guoqing C. Li, Portland, OR (US); Jing Z. Zhu, Hillsboro, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/561,317

(22) Filed: Nov. 17, 2006

(51) Int. Cl. H04Q 7/00

(52) U.S. Cl. 370/329

(57) ABSTRACT

Apparatuses and methods for communicating in a wireless network are described herein. The methods may include initially determining by a device of the wireless network whether a communication channel is available for transmission of signals by using first one or more antennae having a first effective beamwidth to sense energy of the channel. If it is determined that the channel is available for transmission of signals then the device may transmit signals through the channel using a second one or more antennae having a second effective beamwidth, wherein the first effective beamwidth is greater than the second effective beamwidth.

### TECHNICAL FIELD

Embodiments of the present invention relate to the field of data communication, more specifically, to data communication in a wireless network.

### BACKGROUND

The development and popularity of wireless electronic communication in recent years has dramatically increased resulting in wireless local area networks (WLANs) becoming more and more prevalent. A WLAN typically comprises a number of nodes including one or more access points (APs) and stations (STAs). The nodes can come in all kinds of form factors including, for example, as a desktop computer, a laptop computer, a set-top box, a personal digital assistant (PDA), a web tablet, a pager, a text messenger, a game device, a smart appliance, a wireless mobile phone, and so forth.

These WLANs (or simply wireless networks) will typically operate in accordance with a communication standard such as Institute of Electrical and Electronic Engineers (IEEE) 802.11a standard (IEEE std. 802.11a, published 1999) or IEEE 802.11b standard (IEEE std. 802.11b, published 1999). When the nodes of a wireless network are to communicate within the network, the nodes will typically communicate through a particular communication channel. The term “communication channel” as used herein may refer to a particular frequency band such as one of the non-license bands including, for example, the 2.4 GHz band, or one of the licensed bands. Before a node communicates in a WLAN, the node will typically first perform a channel clear assessment (CCA) to determine whether a channel is available for communication (i.e., transmission and/or reception of signals). In CCA, the energy level of a channel is sensed in order to determine whether the channel is being used by another node of the same WLAN or another WLAN. By performing a CCA, collisions of data packets from different nodes can be reduced or avoided.

In recent years, the use of sector antennas at client devices has been contemplated. Sector antennas as opposed to, for example, omnidirectional antennas have relatively narrow beamwidths. The use of sector antennas has been shown to provide certain advantages. For example, it has been found that by using sector antennas, greater transmission and reception ranges and greater data throughput may be achieved. One drawback of using sector antennas is the issue of deafness and hidden node problem that results from the relatively narrow beamwidths associated with sector antennas. Deafness and hidden node problem is a phenomenon that may occur when, for example, sector antennas are used to determine whether a channel is clear or busy (i.e., CCA operations). In particular, the deafness and hidden node problem may occur when a node is unable to detect or sense signals generated by another node because the node is using an antenna or antennae with a fairly narrow effective beamwidth. The deafness and hidden node problem can be particularly significant in, for example, a high density WLAN environment in which many nodes are located in a relatively small geographical area.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates the beamwidth of a device with a sector antenna in accordance with various embodiments of the present invention;

FIG. 2 illustrates the effective beamwidth of a device with two sector antennas in accordance with various embodiments of the present invention;

FIG. 3 illustrates the effective beamwidth of a device with eight sector antennas in accordance with various embodiments of the present invention;

FIG. 4 illustrates a wireless network with a station that is transmitting signals to an access point in accordance with various embodiments of the present invention;

FIG. 5 illustrates an apparatus for communicating in a wireless network in accordance with various embodiments of the present invention;

FIG. 6 illustrates another apparatus for communicating in a wireless network in accordance with various embodiments of the present invention; and

FIG. 7 illustrates a system in accordance with various embodiments of the present invention.

### DETAILED DESCRIPTION OF ILLUSTRATIVE EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the instant description, the phrase “A/B” means A or B. For the purposes of the instant description, the phrase “A and/or B” means “(A), (B), or (A and B).” For the purposes of the instant description, the phrase “at least one of A, B and C” means “(A), (B), (C), (A and B), (A and C), (B and C) or (A, B and C).” For the purposes of the instant description, the phrase “(A)B” means “(B) or (AB),” that is, A is an optional element.

The description may use the phrases “in various embodiments,” or “in some embodiments,” which may each refer to one or more of the same or different embodiments. Furthermore, the terms “comprising,” “including,” “having,” and the like, as used with respect to embodiments of the present invention, are synonymous.

According to various embodiments of the present invention, methods and apparatuses are provided that may allow a wireless network device to avoid the deafness and hidden node problem. For the embodiments, the methods may include initially determining by a device of a wireless network whether a channel is available for communication (e.g., transmission of signals) by using a first one or more antennae having a first effective beamwidth to sense energy of the channel. If it is determined that the channel is available for communication, the device may then communicate through the channel using a second one or more antennae having a second effective beamwidth, wherein the first effective beamwidth being greater than the second effective beamwidth. These and other aspects of various embodiments of the present invention will be discussed in greater detail below.

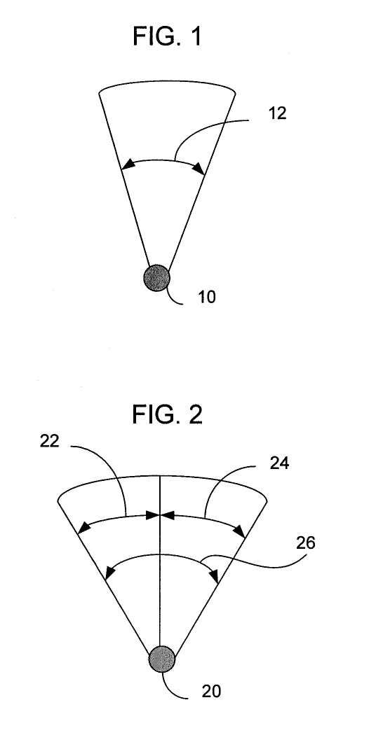

FIG. 1 illustrates a beamwidth of a device with a sector antenna in accordance with various embodiments of the present invention. The sector antenna (not depicted) of the device 10 may be associated with a relatively narrow beamwidth 12 as shown. Referring now to FIG. 2 illustrating an effective beamwidth of a device with two sector antennas in accordance with various embodiments of the present invention. The two sector antennas (not depicted) of device 20 are each associated with distinct and relatively narrow beamwidths 22 and 24. In this example, each of the two sector antennas are facing different directions, the two beamwidths 22 and 24 of the two sector antennas being adjacent to each other though there may be some overlap between the two beamwidths 22 and 24. The two beamwidths 22 and 24 may combine to form an effective beamwidth 26. Note that the terms “antennas” and “antennae” will be used interchangeably throughout this description and are therefore synonymous.

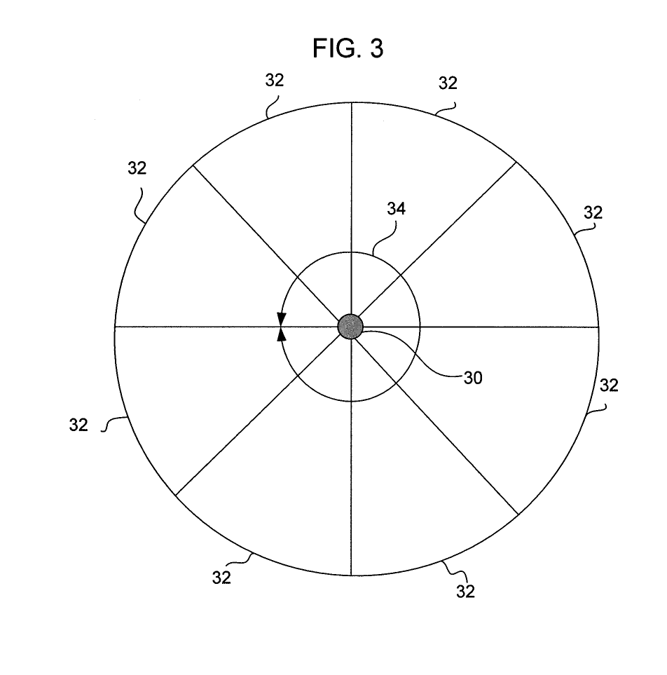

FIG. 3 illustrates beamwidths of a device with multiple sector antennae in accordance with various embodiments of the present invention. The device 30 includes eight sector antennas (not depicted) that face different directions and that are each associated with eight relatively narrow beamwidths 32. The beamwidths 32 may combine to form an effective beamwidth 34 that encircles the device 30 (i.e., 360° degrees of effective beamwidth). By having such an effective beamwidth 34, the device 30 may be able to receive (as well as transmit) signals from all directions. Further, by having such an effective beamwidth 34, the energies from all directions may be determined for a CCA. Note that in alternative embodiments, rather than using multiple sector antennae to produce 360° degrees of effective beamwidth 34, the 360° degrees of effective beamwidth 34 may be obtained by using a single omnidirectional antenna.

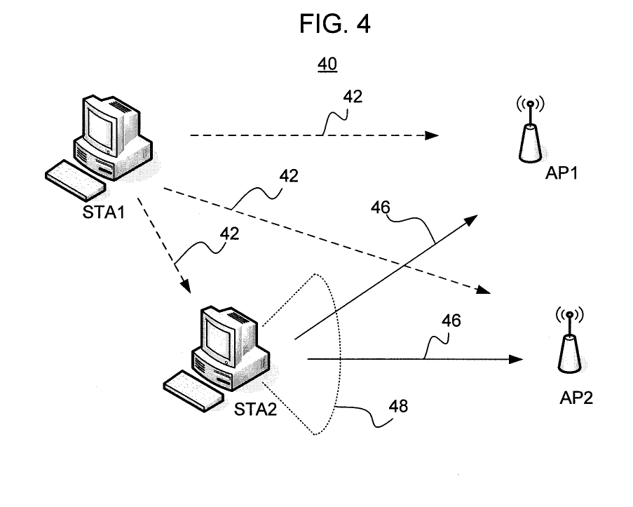

FIG. 4 illustrates a wireless network with two stations (STA1 and STA2) and two access points (AP1 and AP2) in accordance with various embodiments of the present invention. Note that although only four nodes (i.e., STA1, STA2, AP1, and AP2) have been included in the wireless network 40, in alternative embodiments, greater or fewer nodes may be included in the wireless network 40. For the embodiments, STA2 may employ a plurality of antennas for communicating in the wireless network 40. In particular, STA2 may employ a first one or more antennae having a first effective beamwidth for sensing energy of a communication channel (herein “channel”) to determine whether the channel is available for communication including transmission of signals. Note that the sensing of the energy of the channel and the determination of whether a channel is available for communication based on the energy sensed will be described in greater detail below.

If the channel is determined to be available for transmission of signals then STA2 may employ a second one or more antennae having a second effective beamwidth for transmitting signals. In some embodiments, the first effective beamwidth of the first one or more antennae may be greater than the second effective beamwidth of the second one or more antennae. For these embodiments the first effective beamwidth may be a relatively broad effective beamwidth while the second effective beamwidth may be a relatively narrow effective beamwidth (the second effective beamwidth depicted by reference 48).

In order for STA2 to transmit signals 46 to AP2, STA2 may initially perform a channel clear assessment (CCA) of a communication channel using the first one or more antennae to sense energy of the channel. If STA1 is using the channel to transmit signals 42 to AP1 at the time that the CCA is being performed by STA2 as depicted in FIG. 4, then the STA2 may sense a relatively high energy level in the channel. This is because by using the first one or more antennae (with the relatively broad effective beamwidth) for the CCA operation, STA2 will be able to detect any signals transmitted by STA1 or any other node located in the vicinity of STA2, which may not be possible if STA2 was using an antenna or antennae with a relatively narrow effective beamwidth (such as by using the second one or more antennae having the relatively narrow second effective beamwidth as depicted by reference 48). It should be noted that in FIG. 4 the signals 42 and 46 are depicted by multiple arrows because signals are typically transmitted in multiple directions even when a sector antenna is used to transmit the signals.

If STA2 determines that the channel is unavailable or busy (i.e., the energy level of the channel is determined to be above some threshold), then STA2 may wait until the channel is determined to be available or free before transmitting signals 46 to AP2. On the other hand, if the channel is determined to be available or free (i.e., the energy level of the channel is determined to be below some threshold), then STA2 may proceed to transmit signals 46 to AP2.

As briefly described earlier if STA2 had used an antenna or antennae with a relatively narrow effective beamwidth (e.g., a single sector antenna) rather than the one or more antennae with the relatively broad effective beamwidth for performing the CCA as described above, then STA2 may erroneously determine that the channel is available for transmission of signals when in fact the channel was actually busy (i.e., the deafness and hidden node problem). That is, if STA2 used an antenna with a relatively narrow beamwidth for CCA, it may not be able to receive the signals 42 transmitted by STA1 during the CCA. As a result, when STA2 tries to transmit signals 46 to AP2, a collision between signals 46 (transmitted by STA2) and signals 42 (transmitted by STA1) may occur at AP2. Similarly, a collision may occur at AP1 between signals 46 (transmitted by STA2) and signals 42 (transmitted by STA1).

In various embodiments of the present invention, the first one or more antennae with the relatively broad effective beamwidth may be a plurality of sector antennas. In some embodiments, if the first one or more antennae are a plurality of sector antennas, then the second one or more antennae may simply be a subset of the plurality of sector antennas. For these embodiments, the subset of the plurality of sector antennas may include one, two, or some other number of sector antennas. In some alternative embodiments, the first one or more antennae may comprise an omnidirectional antenna. For these alternative embodiments, the second one or more antennae may comprise one or more sector antennas. Although the above example was described from the perspective of a station, in various alternative embodiments, an access point may employ a first and a second one or more antennae for communicating in a wireless network as described above.

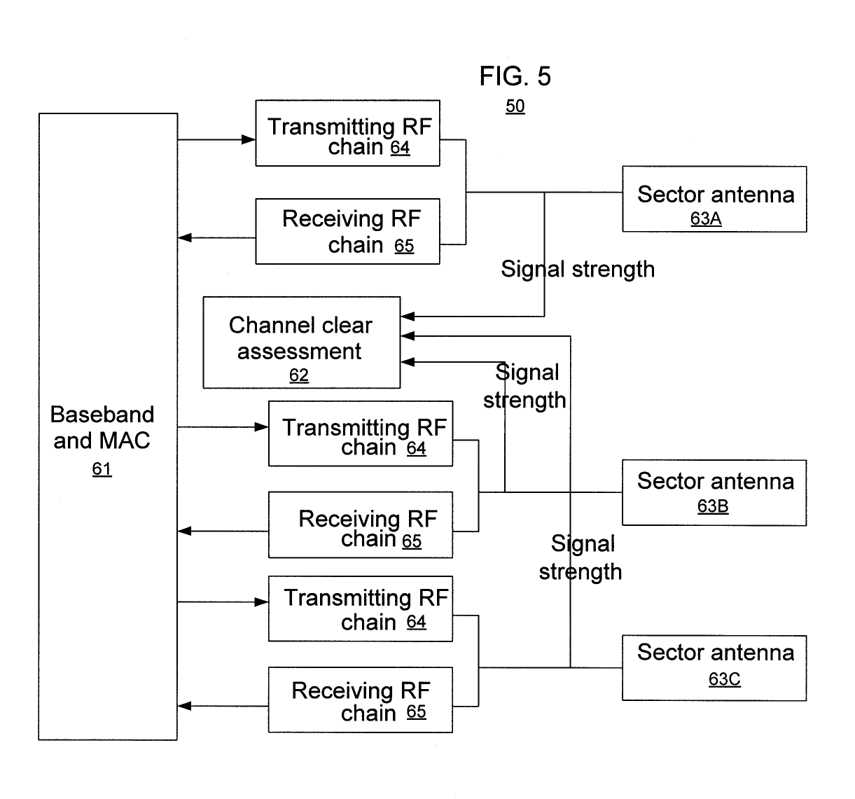

FIG. 5 illustrates an apparatus for communicating in a wireless network using a plurality of sector antennas in accordance with various embodiments. The apparatus 50 includes a baseband and medium access control block 61, a channel clear assessment (CCA) module 62, a plurality of sector antennas 63A to 63C, transmitting radio frequency (RF) chains 64, and receiving RF chains 65, coupled together as shown. Note that although only three sector antennas 63A to 63C are depicted, in alternative embodiments, a greater number of sector antennas may be employed with the apparatus 50. Also, fewer or more transmitting RF and receiving RF chains 64 and 65 may be employed in alternative embodiments.

In various embodiments, the sector antennas 63A to 63C may each face a different direction. In some embodiments, this may mean that the effective beamwidth of the sector antennas 63A to 63C is 360° degrees allowing the sector antennas 63A to 63C to receive signals from any direction.

The CCA module 62 may be adapted to perform the various operations as previously described for STA2 of FIGS. 4 and 5. In particular, the CCA module may perform the CCA operations previously described by determining whether a communication channel of a wireless network is available for communication (i.e., transmission of signals) by using all of the sector antennas 63A to 63C to sense the energy of the channel. And if the CCA module 62 determines that the channel is available for transmission of signals, the CCA module 62 may facilitate the transmission of the signals through the channel using only a subset of the sector antennas 63A to 63C. For example, if the CCA module 62 determines that the channel is available for transmission of signals, then the CCA may provide such a determination to the baseband and MAC block 61, and only sector antenna 63A or the combination of sector antennas 63A and 63B may be used for the transmission of the signals.

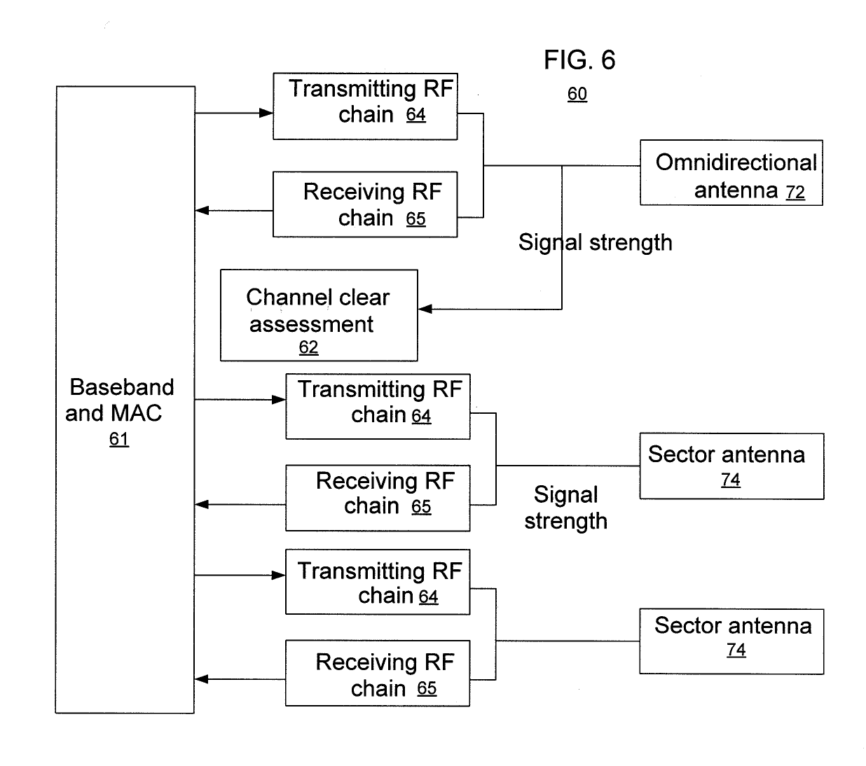

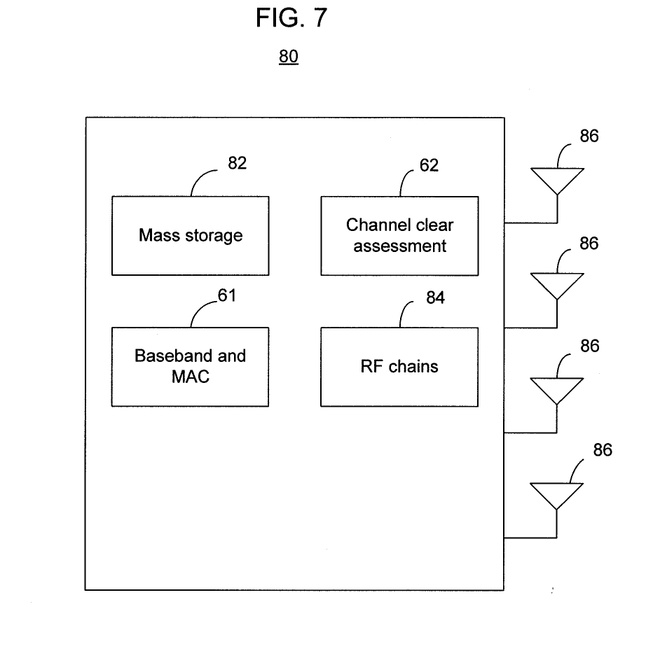

In order to determine whether a channel is available for transmission of signals, the CCA module 62 may “combine” the energies sensed from all directions. This can be realized by combining the energies received from all directions through the multiple sector antennas 63A to 63C (as depicted in FIG. 6) or through a single omnidirectional antenna (as depicted in FIG. 7), and determining an average energy for the channel. Thus, the word “combining” does not necessarily mean “summation” but, instead, “combining” in this context may mean to determine an average energy level for all directions or to determine a weighted average energy level for all directions (e.g., 0.3 * energy of a first antenna+0.2*energy of a second antenna+ . . . ). The average or weighted average energy level may then be compared to a threshold to determine whether the channel is available for communication. For example, if the average or weighted average energy level of the channel is greater than a threshold, then the channel may be unavailable or busy. On the other hand, if the average or weighted average energy level of the channel is less than the threshold, then the channel may be available or free.

FIG. 6 illustrates another apparatus for communicating in a wireless network using an omnidirectional antenna and a plurality of sector antennas in accordance with various embodiments of the present invention. As depicted, the apparatus 60 includes a baseband and medium access control block 61, a channel clear assessment (CCA) module 62, transmitting radio frequency (RF) chains 64, receiving RF chains 65, and sector antennas 74, similar to the apparatus 50 of FIG. 5. However, unlike the apparatus 50 of FIG. 5, the apparatus 60 includes an omnidirectional antenna 72. Note that although only two sector antennas 74 are depicted, in alternative embodiments, a greater number of sector antennas may be employed with the apparatus 60. Also, fewer or more transmitting RF and receiving RF chains 64 and 65 may be employed in alternative embodiments.

The CCA module 62 may perform the CCA operations previously described for apparatus 50 of FIG. 5 such as determining whether a channel is available for communication (e.g., transmission of signals) based on the energy level of the channel. However, unlike before, the CCA module 62 in this case may employ the omnidirectional antenna 72 to sense energies from all directions to determine whether the channel is available for transmission and/or reception of signals. Upon determining that the channel is available for transmission of signals, one or both of the sector antennas 74 may be used to transmit signals.

In various embodiments, each of the apparatuses 50 and 60 depicted in FIGS. 5 and 6 may include a physical storage medium for storing instructions that are designed to enable the apparatuses 50 and 60 to perform the various operations previously described. For example, these operations include, but are not limited to, determining whether a channel is available for transmission by using a first one or more antennae having a first effective beamwidth to sense energy of the channel. The instructions may further enable the device upon determining that the channel is available for communication to use a second one or more antennae having a second effective beamwidth to transmit signals, wherein the first effective beamwidth being greater than the second effective beamwidth.

FIG. 7 illustrates a system in accordance with various embodiments of the present invention. As depicted, the system 80 may include a mass storage device 82, a baseband and MAC block 61, a channel clear assessment (CCA) module 62, RF chains 84, and a plurality of antennas 86. In some embodiments, the mass storage device 82 may store an operating system. The CCA module 62, as described previously, may perform various CCA operations using one or more of the plurality of antennas 86. The CCA module 62 may be implemented in hardware and/or software. The RF chains 84 may include both transmitting and receiving RF chains. In some embodiments, the plurality of antennas 86 may be comprised of a plurality of sector antennas while in alternative embodiments, at least one of the antennas 86 is an omnidirectional antenna. In various embodiments, the system 80 may be a desktop computer, a laptop computer, a set-top box, a personal digital assistant (PDA), a web tablet, a pager, a text messenger, a game device, a smart appliance, or a wireless mobile phone.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
determining by a device of a wireless network whether a channel is available for transmission of signals by using a first one or more antennae having a first effective beamwidth to sense energy of the channel; and
if determined that the channel is available for transmission of signals, transmitting signals through the channel using a second one or more antennae having a second effective beamwidth, the first effective beamwidth being greater than the second effective beamwidth.

2. The method of claim 1, wherein said determining comprises using the first one or more antennae to sense energies from all directions to determine whether the channel is available for transmission of signals.

3. The method of claim 2, wherein said determining further comprises combining the energies from all directions to determine whether the channel is available for transmission of signals.

4. The method of claim 3, wherein said combining comprises determining an average or weighted average energy level of the channel based on the energies from all directions and comparing the average or weighted average energy level of the channel to a threshold to determine whether the channel is available for transmission of signals.

5. The method of claim 1, wherein said determining comprises using a first one or more antennae comprising an omnidirectional antenna to determine whether the channel is available for transmission of signals.

6. The method of claim 1, wherein said determining comprises using a first one or more antennae comprising a plurality of sector antennae to determine whether the channel is available for transmission of signals.

7. The method of claim 6, wherein said if determined that the channel is available for transmission of signals, transmitting signals through the channel by using a second one or more antennae comprise at least one of the plurality of sector antennae.

8. The method of claim 1, wherein said if determined that the channel is available for transmission of signals, transmitting signals through the channel by using a second one or more antennae comprise one or more sector antennae.

9. An article of manufacture, comprising:
a physical storage medium;
a plurality of executable instructions stored in the physical storage medium designed to program a device to enable the device to:
determine whether a channel of a wireless network is available for transmission of signals by using a first one or more antennae having a first effective beamwidth to sense energy of the channel; and
if determined that the channel is available for transmission of signals, transmit signals through the channel using a second one or more antennae having a second effective beamwidth, the first effective beamwidth being greater than the second effective beamwidth.

10. The article of claim 9, wherein said instructions are adapted to enable said device to perform said determining by using the first one or more antennae to sense energies from all directions to determine whether the channel is available for transmission of signals.

11. The article of claim 10, wherein said instructions are adapted to enable said device to perform said determining by combining the energies from all directions to determine whether the channel is available for transmission of signals.

12. An apparatus, comprising:
a first one or more antennae having a first effective beamwidth;
a second one or more antennae having a second effective beamwidth, the first effective beamwidth being greater than the second effective beamwidth; and
clear channel assessment module coupled to the first and the second one or more antennae to determine whether a channel of a wireless network is available for transmission of signals by using the first one or more antennae to sense energy of the channel, and if determined that the channel is available for transmission of signals, to facilitate transmission of signals through the channel using the second one or more antennae.

13. The apparatus of claim 12, wherein said clear channel assessment module is adapted to said determining by using the first one or more antennae to sense energies from all directions to determine whether a channel is available for transmission of signals.

14. The apparatus of claim 13, wherein said clear channel assessment module is further adapted to combine the energies from all directions to determine whether the channel is available for transmission of signals.

15. The apparatus of claim 14, wherein said clear channel assessment module to said combining by determining an average or weighted average energy level of the channel based on the energies from all directions and comparing the average or weighted average energy level of the channel to a threshold to determine whether the channel is available for transmission of signals.

16. The apparatus of claim 12, wherein said first one or more antennae comprising an omnidirectional antenna.

17. The apparatus of claim 16, wherein said second one or more antennae comprising one or more sector antennae.

18. The apparatus of claim 12, wherein said first one or more antennae comprising a plurality of sector antennae.

19. The apparatus of claim 18, wherein said second one or more antennae comprising at least one of the plurality of sector antennae.

20. A system, comprising:
a mass storage device having an operating system therein;
an apparatus coupled to the mass storage device, the apparatus including:
a first one or more antennae having a first effective beamwidth;
a second one or more antennae having a second effective beamwidth, the first effective beamwidth being greater than the second effective beamwidth; and
clear channel assessment module coupled to the first and the second one or more antennae to determine whether a channel of a wireless network is available for transmission of signals by using the first one or more antennae to sense energy of the channel, and if determined that the channel is available for transmission of signals, to facilitate transmission of signals through the channel using the second one or more antennae.

21. The system of claim 20, further comprising a baseband and medium access control (MAC) block coupled to the first and the second one or more antennae.

22. The system of claim 20, further comprising a plurality of transmitting and receiving radio frequency (RF) chains coupled to the first and the second one or more antennae.

23. The system of claim 20, wherein the system is one selected from the group consisting of a desktop computer, a laptop computer, a set-top box, a personal digital assistant (PDA), a web tablet, a pager, a text messenger, a game device, a smart appliance, or a wireless mobile phone.
